(19) United States
(12) Patent Application Publication
(10) Pub. No.: US 2015/0169195 A1
(43) Pub. Date: Jun. 18, 2015

(54) MULTI-OPERATING SYSTEM AND METHOD USING TOUCH PAD OF OPERATING SYSTEM OF VEHICLE

(71) Applicant: Hyundai Motor Company, Seoul (KR)

(72) Inventor: Jin Young Choi, Seoul (KR)

(21) Appl. No.: 14/559,972

(22) Filed: Dec. 4, 2014

(30) Foreign Application Priority Data
Dec. 18, 2013 (KR) 10-2013-0157785

(51) Int. Cl. G06F 3/0484; G06F 3/0488; G06F 3/0482; G06F 3/041

(52) U.S. Cl. CPC G06F 3/04842; G06F 3/0414; G06F 3/0488; G06F 3/0482

(57) ABSTRACT

A multi-operating system and method using a touch pad of an operating system of a vehicle are provided. The multi-operating system includes a touch pad that is configured to receive a finger flicking gesture input and generate a gesture signal. In addition, a controller is configured to adjust a movement of a focus or items displayed on an information screen in response to receiving the gesture signal from the touch pad. A display unit is configured to display a movement result of the focus or the items displayed on the information screen.

### CROSS-REFERENCE TO RELATED APPLICATION

This application claims under 35 U.S.C. §119(a) the benefit of Korean Patent Application No. 10-2013-0157785 filed on Dec. 18, 2013, the entire contents of which are incorporated herein by reference.

### BACKGROUND

(a) Technical Field

The present invention relates to a multi-operating system using a touch pad of an operating system of a vehicle. More particularly, the present invention relates to a multi-operating system and method using a touch pad of an operating system of a vehicle that improves the use and convenience of an audio video navigation (AVN) operating system mounted within an interior of a vehicle.

(b) Background Art

An Audio Video Navigation (AVN) system refers to a system where in-vehicle audio, multimedia apparatuses and navigation apparatuses are integrated into one system. A typical multimedia system and a typical navigation system, disposed within the AVN system, are integrated into one system. Generally, the AVN system is disposed at a front side of an interior of a vehicle, and has an operating system that includes various types of buttons and dials for operating audio and video around a monitor disposed within a center fascia.

In a related art, dials of the operating system are typically used to operate audio and video of the AVN system. For example, the AVN system may enter a waiting state for audio execution and display an information screen on an AVN monitor and a focus may be displayed on a particular item of the information screen. Thereafter, a user may click or rotate a dial to move the focus to a desired item and select the desired item. More specifically, a user may click a left or right side of a dial to switch the information screen of the monitor and thus change the information screen into another information screen, and may also rotate the dial to scroll through pages of the information screen by moving a plurality of items forming a list on the information screen one by one.

The switching of the information screen and the selection of the item by the movement of the focus using the dial as described above may be inconvenient for a user and cause user discomfort which may result from continuous use of the dial.

The above information disclosed in this section is merely for enhancement of understanding of the background of the invention and therefore it may contain information that does not form the prior art that is already known in this country to a person of ordinary skill in the art.

### SUMMARY

The present invention provides a multi-operating system and method using a touch pad of an operating system of a vehicle, which may improve the use of the operating system. The multi-operating system may be configured to allow a user to switch an information screen and select items on the information screen using the touch pad, which may be configured to receive finger flicking gestures of the user.

One aspect of the present invention provides a multi-operating system using a touch pad of an operating system of a vehicle that may include: a touch pad configured to receive a finger flicking gesture from a user and generate a gesture signal; a controller configured to adjust a movement of a focus or items displayed on an information screen in response to receiving the gesture signal from the touch pad; and a display unit configured to display a movement result of the focus or the items displayed on the information screen.

In an exemplary embodiment, when the user inputs a one-finger flicking gesture that moves towards a left or right side while contacting the touch pad with one finger (e.g., pressure is exerted by a single touch at a single location), the controller may be configured to move the focus between items on the information screen in a horizontal direction. When the user inputs a one-finger flicking gesture that moves towards an upper or lower side (e.g., top or bottom side of the touch pad) while contacting the touch pad with one finger (e.g., applying pressure to the touch pad), the controller may be configured to move the focus between items on the information screen in a vertical direction. The controller may further be configured to allow the focus to move along the items on the information screen one by one (e.g., one item at a time) in response to the one-finger flicking gesture.

In another exemplary embodiment, when the user inputs a two-finger flicking gesture that moves towards a left or right side while contacting the touch pad with two fingers (e.g., pressure is exerted/applied by two touches at two locations), the controller may be configured to move the focus between different information screens. The different information screens may include a superordinate information screen and a subordinate information screen that may be linked together. Further, in response to receiving an input of a two-finger flicking gesture moving in an upper or lower side while contacting the touch pad with two fingers, the controller may be configured to simultaneously move the items displayed on the information screen in an upper or lower direction, respectively. Furthermore, the touch pad may be disposed on a surface of a dial of an operating system for an Audio Video Navigation (AVN) system.

Another aspect of the present invention provides a multi-operating method using a touch pad of an operating system of a vehicle. The multi-operating method may include: receiving, by a controller, a gesture signal; moving, by the controller, a focus or items displayed on an information screen of a display unit in response to receiving the gesture signal; and displaying, by the controller, a movement result of the focus and the items on the information screen of the display unit (e.g., moving the focus to a new item or new information screen). In the moving of the focus or the items, when the finger flicking gesture (e.g., the gesture signal) from the user is a one-finger flicking gesture that moves towards a left or right side of the touch pad, the focus may be moved between items on the information screen in a horizontal direction. Further, when the finger flicking gesture from the user is a one-finger flicking gesture that moves towards an upper or lower side of the touch pad, the focus may be moved between items on the information screen in a vertical direction. Furthermore, the focus may be moved, by the controller, along the items on the information screen one by one in response to the one-finger flicking gesture from the user.

In a further exemplary embodiment, in the moving of the focus or the items, when the input finger flicking gesture from the user is a two-finger flicking gesture that moves towards a left or right side, the focus may be moved between different information screens. Further, the different information screens may include a superordinate information screen and a subordinate information screen that are connected together. Additionally, in the moving of the focus or the items, when the finger flicking gesture is a two-finger flicking gesture that moves towards an upper or lower side (e.g., top or bottom side of the touch pad), the items displayed on the information screen may simultaneously move in an upper or lower direction, respectively. In other words, when an information space exceeds one page of the information screen, the items displayed on the information screen may be scrolled in the upper or lower direction. Furthermore, when different information screens are displayed in a vertical direction, the information screens may be switched using the two-finger flicking gesture towards the upper or lower side.

In another further exemplary embodiment, the one-finger flicking gesture may be a finger flicking gesture that moves towards a selected direction of upper and lower sides and left and right sides while the user contacts the touch pad with one finger. Additionally, the two-finger flicking gesture may be a finger flicking gesture that moves towards a selected direction of upper and lower sides and left and right sides while a user contacts the touch pad with two fingers.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view illustrating a multi-operating system using a touch pad of an operating system of a vehicle according to an exemplary embodiment of the present invention;

FIG. 2 is an exemplary view illustrating an application region of a touch pad in a multi-operating system using the touch pad of an operating system of a vehicle according to an exemplary embodiment of the present invention;

FIGS. 3 and 4 are exemplary views illustrating an exemplary movement of a focus displayed on an information screen of a display unit using a multi-operating method according to an exemplary embodiment of the present invention;

FIGS. 5A and 5B are exemplary views illustrating another exemplary movement of a focus displayed on an information screen of a display unit using a multi-operating system according to an exemplary embodiment of the present invention; and

FIG. 6 is an exemplary view illustrating still another exemplary movement of a focus displayed on an information screen of a display unit using a multi-operating system according to an exemplary embodiment of the present invention.

Reference numerals set forth in the Drawings includes reference to the following elements as further discussed below:
1: touch pad
2: controller
3: display unit

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings so that those skilled in the art can easily carry out the present invention.

The present invention, which may improve use of an operating system of an Audio Video Navigation (AVN) system, may also improve operational convenience of the AVN system using a touch pad for a user. In one exemplary embodiment, the movement of a focus on an information screen for the operation of a system may be executed by finger flicking gestures of a user using a touch pad.

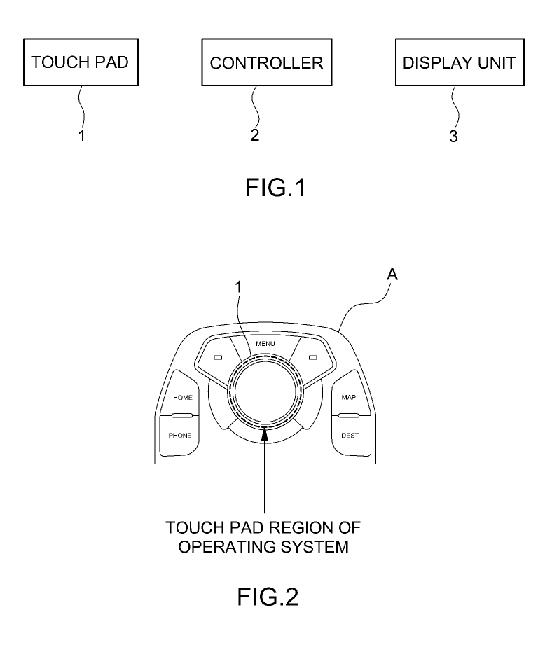

As shown in FIG. 1, a multi-operating system using a touch pad of an operating system according to an exemplary embodiment of the present invention may include a touch pad 1, a controller 2, and a display unit 3. The controller 2 may be configured to operate the touch pad 1 and the display unity 3. The touch pad 1 may be configured to receive the input of finger flicking gestures of a user. When the user inputs a certain finger flicking gesture, the touch pad 1 may be configured to generate a gesture signal in response to the gesture, and transmit the gesture signal to the controller 2.

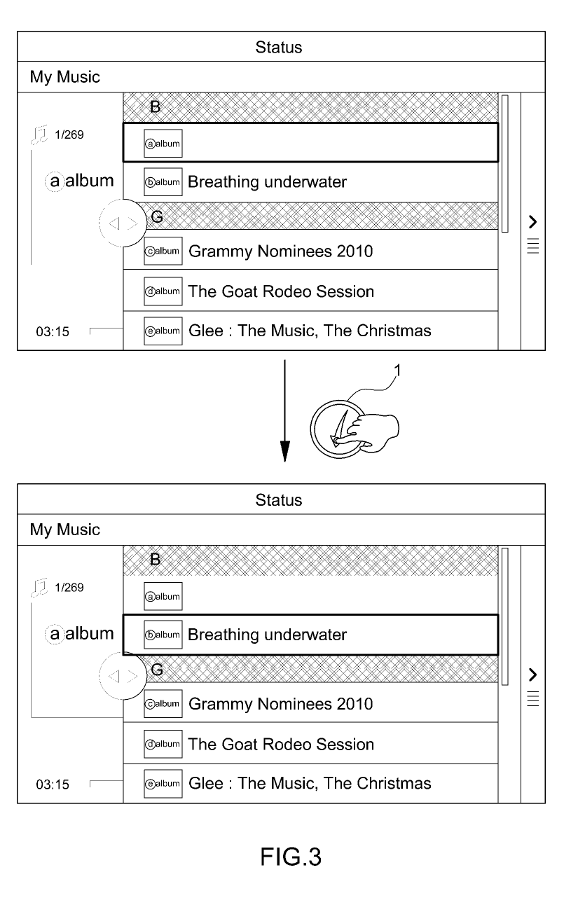

As shown in FIG. 2, the touch pad 1 may be integrally disposed on the surface of a dial that may be part of an AVN operating system (e.g., operating system for AVN system) A. In other words, the touch pad 1 may be disposed within a typical operating system dial. The dial may be configured to allow a switching of an information screen and a selection of a plurality items displayed by the screen using the movement of the focus via the touch pad 11 disposed on the surface thereof. Simultaneously, although not shown, the movement of the focus may be performed using the dial itself. More particularly, the focus on the information screen of the display unit 3 may be moved in vertical and horizontal directions among the items displayed on the information screen in response to clicking an upper or lower side of the dial or rotating the dial.

The controller 2 may be configured to execute the movement of the focus of the information screen in response to the gesture signal from the touch pad 1. The controller 2 may also be configured to switch the information screen displayed on the display unit 3 to a different information screen in response to receiving the movement of the focus between information screens, or change a selected item (e.g., item indicated by the focus) into another item in response to the movement of the focus between the items displayed on the information screens. Further, the controller 2 may be configured to receive the gesture signal from the touch pad 1 and recognize the finger flickering gestures inputted by a user. Accordingly, the controller 2 may be configured adjust the movement of the focus based on the recognized gestures. Additionally, an item of the information screen indicated by the focus (e.g., the selected item) may wait for the user's execution through a separate operation, not shown.

The display unit 3 may be configured to output the information screen where the focus is displayed on a particular item. The display unit may also be configured to move the focus of the information screen in response to the command of the controller 2. For example, the display unit 3 may be configured to allow a user to visually confirm the switching of the information screen and the change of a selected item in the information screen by outputting the results of the switching of the information screen and the change of the selected item generated by the movement of the focus in response to a control signal of the controller 2. Further, the display unit 3 may include an AVN monitor.

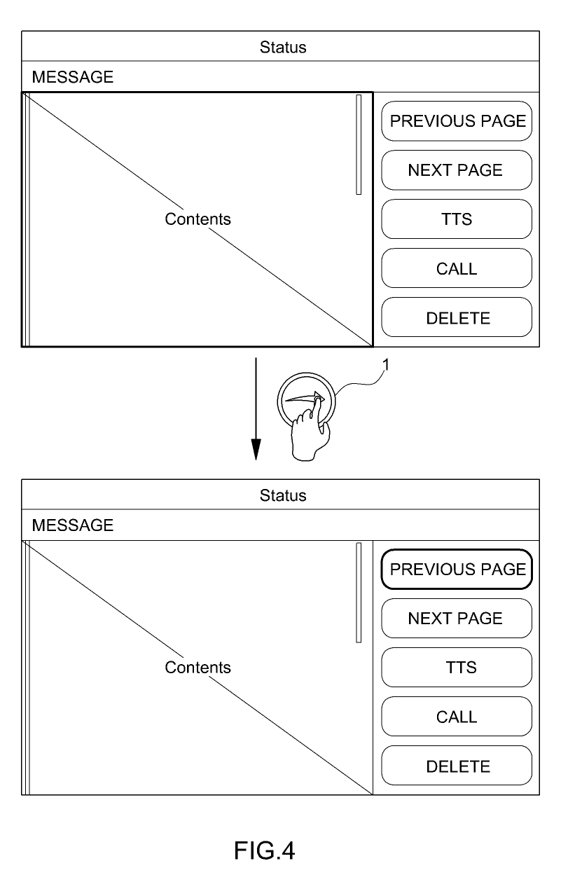

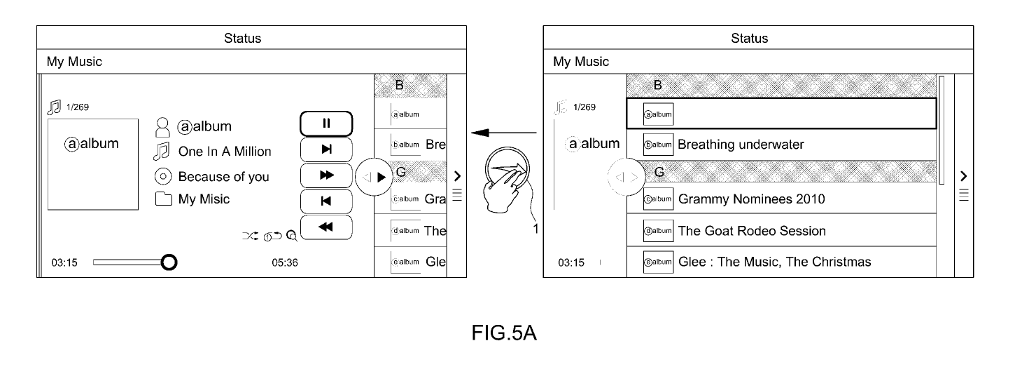

Hereinafter, a multi-operating method using the touch pad 1 will be described with reference to FIGS. 3 to 6. FIGS. 3 and 4 illustrate an exemplary movement of the focus in the information screen in response to a one-finger flicking gesture in accordance with an exemplary embodiment of the present invention. FIG. 3 illustrates an exemplary focus movement method using the touch pad 1, and shows an information screen for operating an audio displayed on the display unit 3 according to an exemplary embodiment of the present invention. FIG. 4 illustrates another exemplary focus movement method using the touch pad 1, and shows an information screen for confirming a message displayed on the display unit 3 according to an exemplary embodiment of the present invention.

As shown in FIGS. 3 and 4, when a user inputs one-finger flicking gestures in vertical and horizontal directions, the focus in the information screen may be moved by the finger flicking gestures of the user. More specifically, when a user inputs a finger flicking gesture in which one finger moves from a lower side towards an upper side (or from a upper side towards an lower side) of the touch pad 1 while contacting the touch pad 1, the focus of the information screen may be moved to a next item under (or above) a selected item of an item list arranged in a vertical direction. Alternatively, when the user inputs a finger flicking gesture in which one finger moves from a left side towards a right side (or from a right towards a left side) of the touch pad 1 while contacting the touch pad 1, the focus of the information screen may move from a left item to a right item (or from a right item to a left item) among items in a horizontal direction. Additionally, when a user inputs a certain one-finger flicking gesture to the touch pad 1, the focus may be moved one by one (e.g., one item at a time) among the items arranged in a vertical direction or a horizontal direction on the information screen until a desired item is reached.

The upper drawing of FIG. 3 shows an information screen that displays a music item list, and the focus is located at the first item of the item list. The lower drawing of FIG. 3 shows a changed screen when the selected item is changed based on the movement of the focus, and the focus is moved to the second item of the item list in response to the movement of the focus. Referring to FIG. 3, when the user inputs a one-finger flicking gesture from an upper side to a lower side (e.g., a top side to a bottom side) of the touch pad 1, the focus may be moved downwardly from the first item to the next item in the item list that is vertically arranged, and indicate the second item. Alternatively, although not shown, when a user inputs a one-finger flicking gesture to the touch pad 1 from a lower side to an upper side of the touch pad 1, the focus may be moved upwardly move from the selected item to the next item in the item list that is vertically arranged.

The upper drawing of FIG. 4 shows an exemplary view where the focus located at a message contents item at the left side of the screen. The lower drawing of FIG. 4 shows an exemplary view where the focus is moved to the first item of a right item list based on the movement of the focus in response to an input of a one-finger flicking gesture from the user. Referring to FIG. 4, when a user inputs a one-finger flicking gesture to the touch pad 1 from a left side to a right side of the touch pad 1, the focus of the message screen may be moved from a left item to a right item by one item and indicate the right item. Alternatively, when a user inputs a one-finger flicking gesture from a right side towards a left side of the touch pad 1, the focus of the message screen may be moved from a right item to a left item by one item and indicate the left item.

As described above, the multi-operating system according to one exemplary embodiment of the present invention may also move the focus by clicking or rotating the operating system dial without the touch pad 1. More particularly, when the focus is located at a certain second item in the information screen and an upper side (or lower side) of the dial is clicked, the focus may be moved upwardly to the first item above the second item (or the third item under the second item). Additionally, when the focus is located at a certain fifth item in the information screen and the dial is rotated in a clockwise direction (or a counterclockwise direction), the focus may be moved to the sixth item located at the right side of the fifth item (or the fourth item located at the left side of the fifth item).

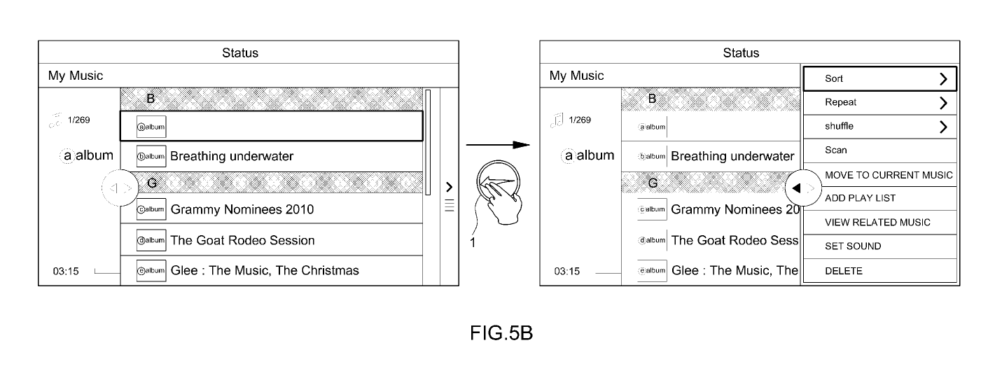

FIGS. 5A and 5B illustrate an exemplary switching of the information screens in response to to a two-finger flicking gesture and an information screen displayed on the display unit 3 showing the exemplary switching of the information screens and the movement of the focus using the touch pad 1 in accordance with an exemplary embodiment of the present invention. As shown in FIG. 5A, when the user inputs a two-finger flicking gesture in a horizontal direction on the touch pad 1, the switching of the information screen may be performed in response to the finger flicking gesture of the user. In other words, when the user inputs the two-finger flicking gesture from a left side towards a right side (or a right side towards a left side) of the touch pad 1 while contacting the touch pad 1, the information screen displayed may be changed.

When the information screen is changed, the first information screen may be switched into the second information screen, and simultaneously, the focus located at a certain item in the first information screen may be moved to a random item (or a predetermined item) in the second information screen. In other words, the movement of the focus may occur concurrently with the information screen switch. Subsequently, the focus may not be moved between the items within one information screen (see FIGS. 3 and 4), but between two different information screens. Accordingly, when the user inputs a certain two-finger flicking gesture, the information screen of the display unit 3 may be changed into another information screen. For example, a subordinate information screen may be changed into a superordinate information screen, or vice versa based on the two-finger flicking gesture.

The right drawing of FIG. 5A is an exemplary screen that displays a music list and shows that the focus may be located at the first item of the music list in the information screen. The left drawing of FIG. 5A is an exemplary screen that displays a changed information screen based on the switching of the information screen. The changed information screen may include a selected item (e.g., playable music) and may show the focus is located at the pause item for pausing the play of the music.

The left drawing of FIG. 5B is an exemplary screen that displays a music list, and shows that the focus may be located at the first item of the music list. The right drawing of FIG. 5B is an exemplary screen that displays a changed information screen based on the switching of the information screen. The changed information screen may show various selectable audio operation option items and the focus may be located at the first item of the item list in the information screen.

As shown in FIG. 5A, when a user inputs a two-finger flicking gesture from a left side to a right side of the touch pad 1, the focus may be moved from a superordinate information screen to a subordinate information screen, and simultaneously, the superordinate screen may be changed into the subordinate information screen. Alternatively, as shown in FIG. 5B, when a user inputs a two-finger flicking gesture from a right side to a left side of the touch pad 1, the focus may be moved from a subordinate information screen to a superordinate information screen, and simultaneously, a subordinate screen may be changed into a superordinate information screen.

In the multi-operating system according an exemplary embodiment of the present invention, the information screen may be configured to switch to another information screen by flicking the touch pad 1 with two fingers as described above. In other words, the focus may not be moved in one information screen, but may be moved between different two information screens (e.g., a superordinate information screen and a subordinate information screen) to change the information screen.

Further, the multi-operating system may be configured to allow the information screen to be switched without the touch pad 1. More specifically, when the focus is located at a certain item (or a predetermined item) within the information screen and a left or right side of the dial is clicked, the focus may be moved between two different information screens and switch the information screen.

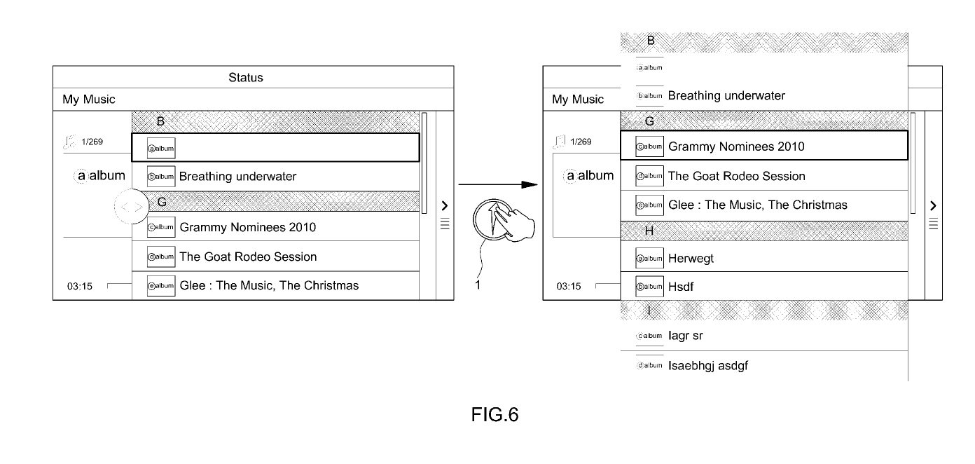

FIG. 6 illustrates an exemplary scroll movement of the information screens in response to a two-finger flicking gesture and an exemplary information screen displayed on the display unit 3 showing the scroll movement of the information screen using the touch pad 1 in accordance with an exemplary embodiment of the present invention. In particular, the scroll movement may show that a plurality of items (e.g., an item list) may be moved in a vertical direction together. In this case, the focus may be moved to a predetermined item (e.g., the first or last item displayed on the information screen).

When a user inputs a two-finger flicking gesture in a vertical direction on the touch pad 1, an information screen scroll movement may be configured to be performed based on the finger flicking gesture of a user. In other words, when a screen space exceeds one page of the information screen and the user inputs a two-finger flicking gesture where the gesture moves from a lower side to an upper side (or an upper side to a lower side) of the touch pad 1 while contacting the touch pad 1, the item list displayed may be moved, by the controller, in an upper or lower direction and change some or all of the items displayed on the information screen.

Subsequently, when the items displayed move in an upper or lower direction, the focus may be moved to a predetermined location (e.g., the first item of the item list of the information screen). In other words, when a user inputs a two-finger flicking gesture, the focus may be located at the first item of the items displayed on the information screen, and the items displayed on the information screen may be simultaneously moved in an upper or lower direction, changing the item list displayed on the information screen.

Further, when a user inputs a predetermined two-finger flicking gesture to the touch pad 1, the focus may be prevented from moving in the information screen, and the items may be simultaneously moved in an upper or lower direction, changing the items of the information screen. When different information screens are displayed in a vertical direction and the user inputs a two-finger flicking gesture moving towards an upper or lower side on the touch pad 1, the information screens may be switched, by the controller, between the information screens displayed in the vertical direction in response to the finger flicking gesture of the user.

The left and right drawings of FIG. 6 are exemplary screens that display a music list and the focuses are located at the first item of the item list in the information screens, respectively. Referring to FIG. 6, when a user inputs a two-finger flicking gesture to the touch pad 1 from a lower side towards an upper side of the touch pad 1, the focus may be fixed on the first item in the information screen and the items in the information screen may be moved from a lower side towards an upper side. Consequently, some items arranged at the upper side of the information screen may disappear from the screen, and new items may appear on the lower side (e.g., bottom) of the information screen, which allows items arranged at the center of the information screen to be moved to a first location of the items (e.g., item list) displayed in the information screen.

Alternatively, although not shown, when a user inputs a two-finger flicking gesture to the touch pad 1 from an upper side to a lower side of the touch pad 1, all of the items in the information screen may be moved from an upper side towards a lower side. Consequently, one or more items arranged at the lower side of the information screen may be configured to disappear (e.g., may be eliminated or removed by the controller) from the screen, and new items may appear on (e.g., may be added by the controller) the upper side of the information screen, which allows items arranged at the center of the information screen to move to a last location of the items displayed in the information screen. In particular, the focus may be fixed at the first item of the information screen.

As described above, the multi-operating system according to the exemplary embodiment of the present invention may be configured to move items on the information screen out of the information screen by flicking the touch pad 1 with two fingers, which allows the items disappear through simple screen movement. Additionally, the multi-operating system may change items displayed in the information screen by simply rotating the operation system dial without the touch pad 1. More specifically, when a user rotates the dial in one direction when the focus is fixed at the first item (or a predetermined item) in the information screen, the uppermost item of the items displayed in the information screen may be moved upwardly one by one and thus may be configured to disappear from the information screen, or the lower most item may be moved downwardly one by one and thus may be disappear from the information screen. Accordingly, the items displayed in the information screen may be sequentially changed, which may result in scroll movement of the information screen.

Thus, the multi-operating system according to the embodiment of the present invention has an advantage of improving the operability and convenience of the operating system using the touch pad 1, thereby improving the usability due to a convenience of the operation of the AVN system. The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A multi-operating system using a touch pad of an operating system of a vehicle, comprising:
a touch pad configured to receive a finger flicking gesture input and generate a gesture signal; and
a controller configured to:
receive the gesture signal from the touch pad;
move a focus or items displayed on an information screen in response to receiving the gesture signal; and
output on a display a movement result of the focus or the items displayed on the information screen.

2. The multi-operating system of claim 1, wherein in response to receiving a one-finger flicking gesture that moves towards a left or right side of the touch pad while pressure is exerted on the touch pad, the controller is further configured to move the focus between items arranged on the information screen in a horizontal direction.

3. The multi-operating system of claim 2, wherein in response to receiving a one-finger flicking gesture that moves towards an upper or lower side of the touch pad while pressure is exerted on the touch pad, the controller is further configured to move the focus between items arranged on the information screen in a vertical direction.

4. The multi-operating system of claim 3, wherein the controller is further configured to move the focus along the items on the information screen one item at a time in response to receiving the one-finger flicking gesture input.

5. The multi-operating system of claim 1, wherein in response to receiving a two-finger flicking gesture that moves towards a left or right side of the touch pad while pressure is exerted on the touch pad, the controller is further configured to move the focus between different information screens.

6. The multi-operating system of claim 5, wherein the different information screens include a superordinate information screen and a subordinate information screen linked together.

7. The multi-operating system of claim 1, wherein in response to receiving a two-finger flicking gesture that moves towards an upper or lower side of the touch pad while pressure is exerted on the touch pad, the controller is further configured to simultaneously move the items displayed on the information screen in an upper and lower direction, respectively.

8. The multi-operating system of claim 1, wherein the touch pad is disposed on a surface of a dial of an operating system for an Audio Video Navigation (AVN) system.

9. A multi-operating method using a touch pad of an operating system of a vehicle, comprising:
receiving, by a controller, a gesture signal from a touch pad;
moving, by the controller, a focus or items displayed on an information screen of a display in response to receiving the gesture signal; and
displaying, by the controller, a movement result of the focus and the items on the information screen.

10. The multi-operating method of claim 9, wherein the moving of the focus or the items further comprises:
moving, by the controller, the focus between items on the information screen in a horizontal direction in response to receiving a finger flicking gesture input that is a one-finger flicking gesture moving towards a left or right side of a touch pad.

11. The multi-operating method of claim 10, wherein the moving of the focus or the items further comprises:
moving, by the controller, the focus between items on the information screen in a vertical direction in response to receiving the finger flicking gesture input that is a one-finger flicking gesture moving towards an upper or lower side of the touch pad.

12. The multi-operating method of claim 11, further comprising:
moving, by the controller, one item at a time in response to receiving the one-finger flicking gesture.

13. The multi-operating method of claim 12, wherein the flicking gesture input is a finger flicking gesture moving in a selected direction of upper and lower sides and left and right sides while pressure is exerted on the touch pad with one finger.

14. The multi-operating method of claim 9, wherein the moving of the focus or the items further comprises:
moving, by the controller, the focus between different information screens in response to receiving a finger flicking gesture input that is a two-finger flicking gesture moving towards a left or right side of a touch pad.

15. The multi-operating method of claim 14, wherein the different information screens include a superordinate information screen and a subordinate information screen linked together.

16. The multi-operating method of claim 14, wherein the moving of the focus or the items, includes:
simultaneously moving, by the controller, the items displayed on the information screen in an upper or lower direction in response to receiving the finger flicking gesture input that is a two-finger flicking gesture moving towards an upper or lower side of the touch pad, respectively.

17. The multi-operating system of claim 16, wherein the flicking gesture input is a finger flicking gesture moving in a selected direction of upper and lower sides and left and right sides while pressure is applied on the touch pad with two fingers.

18. A non-transitory computer readable medium containing program instructions executed by a controller, the computer readable medium comprising:
program instructions that receive a gesture signal from a touch pad;
program instructions that adjust a movement of a focus or items displayed on an information screen in response to receiving the gesture signal; and
program instructions that display a movement result of the focus or the items displayed on the information screen.

19. The non-transitory computer readable medium of claim 18, further comprising:
program instructions that move the focus between items on the information screen in a horizontal direction in response to receiving a one-finger flicking gesture moving towards a left or right side of a touch pad.

20. The non-transitory computer readable medium of claim 19, further comprising:
program instructions that move the focus between items on the information screen in a vertical direction in response to receiving a one-finger flicking gesture moving towards an upper or lower side of the touch pad.
